(19) United States
(12) Patent Application Publication
(10) Pub. No.: US 2013/0056305 A1
(43) Pub. Date: Mar. 7, 2013

(54) Elevator With Cogged Belt and Pulley and With Counterweight

(71) Applicants: Jose Luis Blanco Sanchez, Madrid (ES); Borislav Zvetkov Martinov, Madrid (ES)

(72) Inventors: Jose Luis Blanco Sanchez, Madrid (ES); Borislav Zvetkov Martinov, Madrid (ES)

(21) Appl. No.: 13/605,410

(22) Filed: Sep. 6, 2012

(30) Foreign Application Priority Data
Sep. 7, 2011 (ES) 201100835

(51) Int. Cl. B66B 11/08; B66B 7/02

(52) U.S. Cl. 187/255

(57) ABSTRACT

An elevator has deflecting pulleys above or below a car, fastenings for securing the ends of a cogged belt disposed in an upper portion of a hoistway. A machine is formed by a gearless motor on the shaft of which are assembled at least one cogged pulley made of a single part with helical cogs and with a diameter greater than 100 mm. The machine has a support, a brake, an integrated deflecting pulley, and non-slip rollers, all of these elements being mounted on a base. The machine is in a projection of a counterweight. The counterweight is disposed at a side of the hoistway. The cogged belt has steel reinforcement cables embedded in transparent polyurethane and the cogged portion is covered with a textile mesh. This configuration achieves a reduction of noise level and uniform translation of the car.

### CROSS-REFERENCE TO RELATED APPLICATIONS

This application claims the priority, under 35 U.S.C. §§ 119 and 371, of Spanish patent application No. 201100835 filed Sep. 7, 2011; the prior application is herewith incorporated by reference in its entirety.

### STATEMENT REGARDING FEDERALLY SPONSORED RESEARCH OR DEVELOPMENT

Not Applicable

### FIELD OF THE INVENTION

The present invention lies in the field of elevators. The present disclosure relates to an elevator driven by a cogged belt and pulley system imparting translational movement to the car and counterweight elements of the elevator. The main feature of the system, due to its working principle, is its traction capacity, which does not allow the relative movement between the cogged belt and the cogged pulley, even with a very light car. These features provide several advantages, such as the possibility of increasing the useful load and reducing the size of the elements of the elevator. Among other objectives of the elements and the distribution thereof is to particularly achieve a greater use of the elevator hoistway, both of its dimensions in length and width and of the heights of the upper and lower areas.

The present invention is characterized in the design and configuration both of the drive and the elements and measures forming part of the object of the invention, with the dual objective of achieving a reduction of noise levels generated and a uniform translation of the car and with a high comfort level.

As a result of the present invention, moving the car without sliding between the belt and the driving pulley is achieved even with a car having a minimum weight, which enables a lowering of its cost and further achieving an optimum use of the dimensions of the hoistway. Finally, the use of cogged belts allows for a reduction in the torque necessary for lifting and lowering the car in comparison with a cable having a circular section of the same strength.

Therefore, the present invention is encompassed within the scope of elevators and particularly those that are moved by a cogged pulley and belt and among elevators with counterweight.

### BACKGROUND OF THE INVENTION

Patent documents disclosing different of types and measures for the traction of the car of an elevator are known in the state of the art in which the following is highlighted.

Patent Document ES 2272055 T3 discloses an elevator with counterweight with flat cables. The use of flat cables allows a reduction in the size of the drive of the motor because the flexural rigidity is much less. The motor is positioned between the wall and the car to make use of the entire elevator hoistway along its height, also fixed to the wall or ceiling.

Traction with flat cables does not prevent sliding between the pulley and the belt. On the other hand, the fact that the diameter of the pulley is less than 100 mm means that the number of revolutions is high, which causes a higher noise level and a reduction in comfort level.

Therefore, relating to this invention, an elevator with counterweight is provided in which the sliding between the pulley and the belt are prevented using a cogged pulley and a cogged belt and, additionally, in reducing the noise level and improving the comfort levels by making sure that the pulley is greater than 100 mm in diameter.

International Patent Publication WO 99/43602 discloses an example of an elevator system with a belt-type flat transmission device. According to this patent application, the elevator car moves by a drive installed in the mass balance weight and moves integrally with the latter. Sliding between the pulley and the belt are not prevented because this device has a flat belt transmission system.

On the other hand, International Patent Publication WO 99/43592 discloses another elevator system with a belt-type transmission device where the drive is integrated in the counterweight, and a belt-type transmission device fixed to the elevator car serves to transmit the driving force between the counterweight and the elevator car.

In the elevator described in Patent Document ES 2262368 T3, the pulley and the type of belt are flat. Therefore, this device has the same problem described for the traction of this type, in which sliding between the pulley and the belt occurs. This device also has the drawback that the diameter of the driving pulley is less than 100 mm, which means that the number of revolutions is high, causing a higher noise level and reduction in comfort.

Until now, cars and counterweights must have a minimum weight to assure the friction traction capacity between the flat cable or belt and the driving pulley. If the minimum weight is not present, sliding between the flat cable or belt and the driving pulley occurs. This means that the car and, accordingly, the counterweight become more expensive because more material is needed. This drawback is solved by Patent Document ES 2280579 T3, which describes a traction device with counterweight made by a cogged pulley, on which there is meshed a cogged belt, which, although preventing sliding between the belt and the pulley, has aspects that are susceptible to being improved, such as, for example, the noise level and the comfort level.

All the systems described are systems for moving the car of an elevator, in several cases with a cogged belt and in other cases with a flat belt. However, these systems have some aspects that are susceptible to being improved, such as those explained below.

On one hand, regardless of whether or not the belt is cogged, the belts do not have any measures for allowing identification when they have suffered from damage, particularly in the steel reinforcement cables embedded in the belt. On the other hand, and particularly in the traction systems with a cogged belt, the noise level generated is relatively high. Therefore, it is considered to be an aspect susceptible to being improved.

Also, lack of precision in the meshing between the cogged pulley and the cogged belt occurs in the cogged belt systems and, particularly, those having a cog arrangement in two rows arranged in a V, as a result of the process of manufacturing cogged pulleys made of two parts attached to one another. This lack of precision results in an increase of the noise level.

Another difficulty or technical aspect susceptible to improvement is the fact that the car does not translate in the most well balanced way possible, it being convenient to avoid horizontal components on the deflecting pulleys. On the other hand, in the elevators systems having a counterweight or in which the machine is not located on the projection of the ceiling of the car, the best use is not made of the hoistway because it is subjected to the constructive conditions of the elevator. A fact that results in a lack of balance in the translation of the car.

Another aspect susceptible to being improved is the fact that the shaft of the driving pulley does not receive the entire load.

Thus, a need exists to overcome the problems with the prior art systems, designs, and processes as discussed above.

### SUMMARY OF THE INVENTION

The invention provides an elevator driven by a cogged belt and pulley system imparting translational movement to the car and counterweight elements of the elevator that overcomes the hereinafore-mentioned disadvantages of the heretofore-known devices and methods of this general type and that provide such features with a reduction in the noise levels generated in the translation and with a well-balanced and uniform translation of the car.

The present invention develops an elevator overcoming the drawbacks described, i.e.:

prevents the sliding between the cogged cable and the cogged pulley;
has measures for quickly identifying possible damage suffered in the reinforcement of the cogged or non-cogged belt;
in the case of cogged belts, reduces the noise level generated;
the cogged pulley and cogged belt mesh with the greatest precision possible;
the car translates in the most well-balanced way possible;
makes the best use of the elevator hoistway; and
the shaft of the cogged pulley does not receive all the force or torque.

With the foregoing and other objects in view, there is provided, in accordance with the invention, an elevator with a cogged belt and pulley having a particular configuration and arrangement of the drive elements, i.e., of the traction machine of the cogged belt and of the associated devices, such as the deflecting pulleys and fastenings for fastening the ends of the cogged belt.

The car of the invention moves vertically through the hole of a building known as the elevator hoistway, where the car is intended for transporting people or goods. The car is guided along the hoistway by a group of guides. The car is suspended from a cogged belt system at one of its ends, a counterweight being suspended at the other end of the cogged belt system. The assembly is driven by a machine located in the upper portion of the hoistway attached (e.g., screwed) to a base located in the upper portion of the hoistway.

By dividing the elevator belt system, there are two ropes in which the tension of the belts is the same. The rope suspending the car owes its tension to the weight of the car itself and on the useful load and, therefore, its tension is variable. On the other hand, the tension of the rope from which the counterweight is suspended depends on the weight of the counterweight.

The car guides and counterweight are vertically supported on the bottom of the hoistway and are fixed to the walls by intermediate supports.

The base together with the machine are inside the hoistway, they can be supported on one of the car guides, on the wall, at the ceiling, on the guides of the counterweight or on any combination of two or three of these four elements. The load distribution will be different in each case. It is possible to transfer the weight of the entire system to the hoistway floor. Therefore, the walls of the building do not have to support the weight of the elevator assembly.

As a result of using a cogged pulley and belt, the sliding between both portions and, therefore, the need of the car and counterweight to have a minimum weight that results in reducing the size of the drive is prevented.

To achieve a quick identification of the possible damage suffered in the cogged belt reinforcement, embedding the steel reinforcement cables in transparent polyurethane is proposed. Thus, if one of the cables of the reinforcement breaks, in addition to being able to visually identify the breakage thereof, an inner bubble facilitating the identification is produced.

To reduce the noise level generated, constructive variations relating to that which is being made until now are proposed, on one hand, increasing the diameter of the driving pulley for the purpose of reducing the number of revolutions, preventing vibrations and therefore noise. On the other hand, and to achieve the aforementioned purpose of reducing the noise levels, the cogs of the driving pulley are helical. The cogs of the cogged belt are straight, which assures a uniform meshing with the cogged belt and not a discontinuous meshing, as has been occurring with the pulleys with non-helical cogs, which further results in a prolongation of the service life of the cogged belt. Furthermore, on the cogged face of the cogged belt there is a textile mesh absorbing and improving the meshing between the pulley and the belt, reducing the noise level.

Furthermore and for the purpose of reducing the noise levels, in the case of cogged belts with the cogs disposed in two rows of inclined cogs forming a V, the cogged pulley was made of a single part because, until now, pulleys were made by producing two halves attached to one another. Therefore, any minimum deviation in the coupling of the two portions of the cogged pulley results in a lack of precision in the meshing and, therefore, to a higher noise level.

To achieve the most well balanced possible translation of the car, a vertical attack of the cogged belt with respect to the pulley has been sought using, to that end, a deflecting pulley integrated with the machine, which prevents any horizontal component in the deflecting or driving pulleys and, therefore, in the car and counterweight, a fact which happens in Patent Document ES 2280579 T3.

The use of a deflecting pulley integrated with the machine further reduces the forces to those that the shaft of the driving pulley would be subjected in the case of not having the deflecting pulley proposed herein and, therefore, reduces the constructive requirements of the shaft.

Furthermore and for the purpose of achieving the most well balanced possible translation of the car, there are anti-slip wheels associated with the driving pulley, which anti-slip wheels are placed with their axes perpendicular to the tangent of the entry and exit points of the cogged belt with respect to the cogged pulley.

The car guides, centrally disposed in relation to the center of masses of the car assembly, also collaborate in the well-balanced translation of the car.

The machine is solely and exclusively located in the projection of the counterweight, enabling a greater use of the dimensions of the hoistway in the upper areas, in addition to preventing horizontal components and therefore preventing more uniform translation.

The cogged pulley and belt mesh along their length and, if they exceed certain limits, the elevator has limit switches or electrical contacts and a torque limiter assuring that the elevator stops at where it has to stop, not providing the belt with cogs in its entire length not being necessary as in other elevators of the state of the art.

Therefore, with the constructive improvements proposed herein, two technical effects are basically achieved, such as, on one hand, noise level reduction and, on the other hand, a well-balanced and uniform translation of the car, the constructive variants described being necessary to achieve both purposes since the constructive features cooperate in the two purposes described, in addition to achieving additional derived technical effects.

Although the invention is illustrated and described herein as embodied in an elevator driven by a cogged belt and pulley system imparting translational movement to the car and counterweight elements of the elevator, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a diagrammatic side elevational view of an exemplary embodiment of an elevator with a configuration of cogged belts and deflecting pulleys;

FIG. 2 is a top plan view of the elevator configuration of FIG. 1;

FIG. 3 is a fragmentary, perspective view of an exemplary embodiment of an assembly including a machine together with cogged pulleys, cogged belts and a deflecting pulley of the elevator of FIG. 1;

FIG. 4 is a fragmentary, perspective view of a portion of the assembly of FIG. 3 with the cogged belt, cogged pulleys, and a meshing or coupling therebetween;

FIG. 5A is a fragmentary, perspective view of the cogged pulley and the cogged belt of FIG. 3;

FIG. 5B is a fragmentary, perspective view of the cogged pulley and the cogged belt of FIG. 3;

FIG. 6A is a fragmentary, front elevational view of an exemplary embodiment of the cogged belt of FIG. 3;

FIG. 6B is a fragmentary, perspective view of the cogged belt of FIG. 6A;

FIG. 6C is a fragmentary, side elevational view of the cogged belt of FIG. 6A;

FIG. 6D is a fragmentary, enlarged, cross-sectional view of a portion the cogged belt of FIG. 6A;

FIG. 6E is a fragmentary, perspective view of the cogged belt of FIG. 6A;

FIG. 7 is a fragmentary, front elevational view of the machine of FIG. 3 together with an exemplary embodiment of non-slip rollers of the cogged belt; and

FIG. 8 is a cross-sectional view of an exemplary embodiment of the deflecting pulley of FIG. 3.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

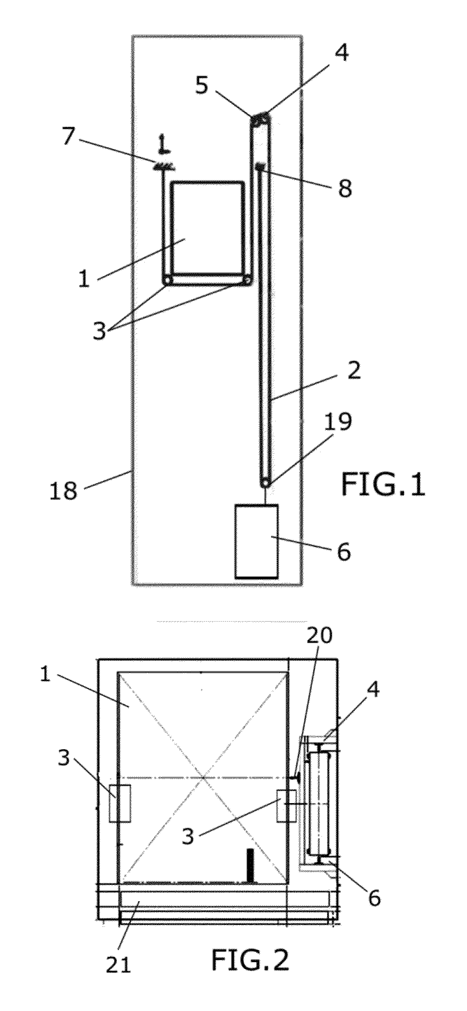

Described now are exemplary embodiments of the present invention. Referring now to the figures of the drawings in detail and first, particularly to FIG. 1, there is shown a first exemplary embodiment of an elevator 1 with an architecture or geometry of the cogged pulleys and belt assembly of the elevator 1 is distributed as set forth in the following. Deflecting pulleys 3 are disposed below the car 1. The pulleys 3 can be mounted on the ceiling or on the lower portion of the car. Fastenings 7 and 8 for fastening the ends of the cogged belt 2 are disposed in an upper portion of the hoistway 18, at which a machine 4 with an integrated deflecting pulley 5 is also disposed. A counterweight 6 is placed on one side of the car 1 below the base of the elevator, and in the projection of the machine.

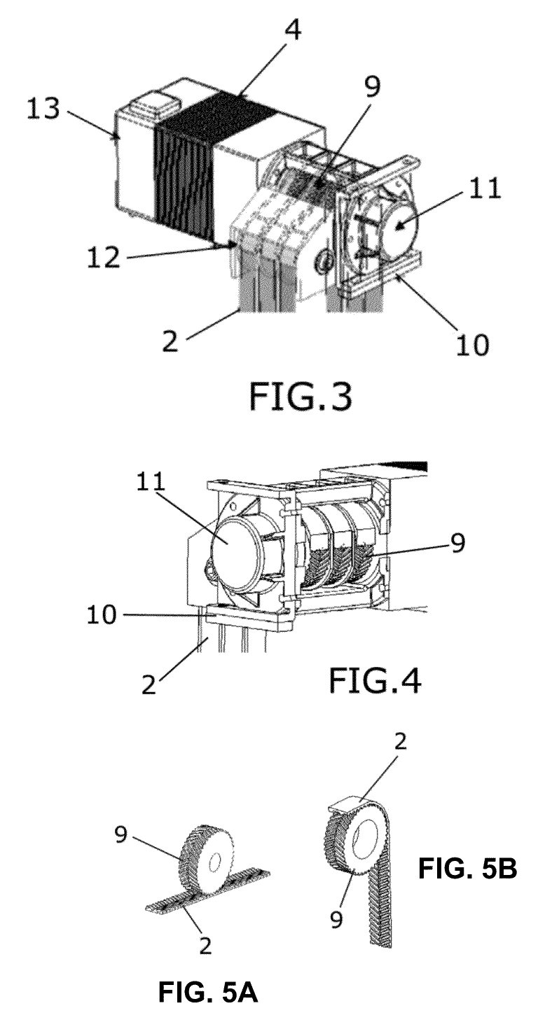

As depicted, it can be observed that the cogged belt 2, starting from a first fixing end 7, passes through the deflecting pulleys 3 of the car 1, which, as has been said, can be disposed in the upper or lower portions of the car 1, followed by the deflecting pulley 5 and by the driving pulley or pinion 9 (FIG. 3) of the machine 4, going to the bottom of the hoistway 18 until reaching the suspension pulley 19 of the counterweight 6, continuing in its final section to the second fixing end 8 of the cogged belt.

The load is suspended from the cogged belts, which are the traction elements replacing a conventional steel cable(s). Lifting is achieved as a result of meshing the cogs of the belt and those of the pulley, which, as a result of the shape thereof, can create the traction necessary for lifting the load. Therefore, the dependency of the elevator operation on the friction forces between the cable and the driving pulley is eliminated.

The axes of the deflecting pulleys 3, which can be above or below the car 1, are perpendicular to the plane of the car guides. The location of the pulleys is moved with respect to the middle plane of the car.

The elevator hoistway 18 and the maximum use thereof can be observed in FIG. 2 as a result of a suitable configuration of the guides, the machine 4, the counterweight 6, and the deflecting pulleys 3.

FIG. 2 shows the position of the cogged belt 2, which is between the car guide 20 and the step 21, which assures a better operation of the elevator as it pulls the center of masses of the car, compensating the door weight.

On the other hand, the car guide 20 passes through the geometric center of the car 1, which assures that the forces of the guide during emergency braking are the least possible.

The driving machine 4 responsible for the traction on the cogged belt 2 is observed in FIG. 3, in which is shown the association of the machine 4 with a cogged pulley 9 and, in turn, the association of the cogged belt 2 with the cogged pulley 9.

The machine 4 has either a brake 11 assembled on a support 10, or a brake 13 mounted in a rear portion of the machine 4. The pulleys are flanked by discs or flanges, which do not allow the belt to come off from its operating position. The cogged pulley 9 and the cogged belt 2 are protected by a casing 12 in their point of meshing.

Because the starting torque required from the machine 4 is not very high, the dimensions of the machine 4 can be reduced, maintaining optimum dimensions between length, width, and height.

FIGS. 4, 5A and 5B illustrate wow the cogged belt 2 meshes with the cogged pulley 9, which cogged pulley 9 is manufactured from metal of a single part and with a groove in the center, has a series of helical cogs located in staggered formation, assures a perfect meshing with the straight cogs of the cogged belt, and results in the reduction of the noise level generated.

In an exemplary embodiment, the diameter of the cogged pulleys is greater than 100 mm, having a width greater than the width of the cogged belt, which can be, in a possible embodiment, 1 mm.

As a result of these constructive features, operation improvement is achieved and the comfort level is increased because the coupling smoothness when moving is increased and, therefore, the vibration and noise are improved. Furthermore, as a result of a cog passage of between 7 mm and 9 mm, an optimum operating speed is achieved, in which the rotation speed is not excessive, such as it would be with a pulley having smaller diameter. Therefore, the vibrations and noise are very low.

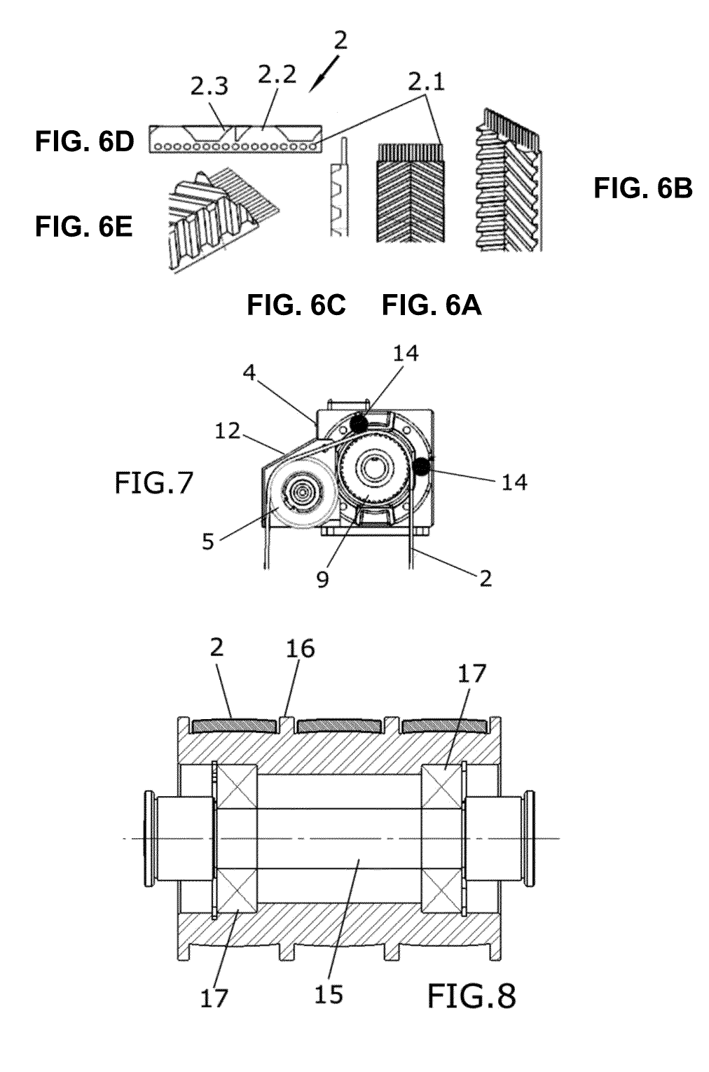

As observed in FIGS. 6A to 6E, the cogged belt 2 has three elements attached to one another by extrusion. The three elements are a plastic portion, several steel cords embedded therein, and a textile mesh.

The textile mesh improves operation and comfort level by increasing the coupling smoothness when moving and, therefore, the vibrations and noise.

The plastic portion has two faces, a flat face and another cogged face. The cogged portion is formed by inclined cogs located in staggered formation and covered by the textile mesh. The cogs form angle of approximately 120°. The passage between the cogs is between 7 mm and 9 mm. The width of the belt can be of different measurements depending on the power and the load to be transmitted. As observed in FIGS. 6A to 6E, the belt 2 has three elements, which include a transparent polyurethane 2.2, steel reinforcement cables 2.1 embedded in the transparent polyurethane 2.2 and a textile mesh 2.3 disposed to cover the cogged portion. The function of the mesh is to reduce the vibrations and noise, whereas the transparent polyurethane allows a visual inspection of the steel reinforcement cables embedded in the polyurethane.

The thickness of the cogged belt with the cogs is between approximately 4 mm to 6 mm. The non-cogged portion has a thickness less than about 3 mm.

All of the elements forming part of the elevator, particularly the cogged belt and pulley, adopt high safety coefficients preventing the breakage of the pulley or belt cogs. Driving in both directions in any direction is, thus, assured. Uncontrolled movement typical for a cable elevator caused by an unbalance between the tension of the two ropes or by the lack of adherence are prevented.

It can be observed in FIG. 7 that the machine 4 has at least two non-slip rollers 14 preventing the belt 2 from coming off and are assembled such that their centers of rotation are perpendicular to the tangent of the entry and exit points of the cogged belt with respect to the cogged pulley. The distance between the non-slip rollers 14 and the pinions or cogged pulleys 9 is sufficient so that the belt 2 passes freely in a well-meshed manner but also prevents the cogs of the belt 2 from coming off the cogs of the pinion 9.

Additionally, the machine 4 has a gearless motor, a support or base, a brake, the two non-slip rollers 14 and a deflecting pulley 5.

It is important to emphasize that the deflecting pulley 5 forms the indivisible portion of the machine 4 and prevents the inclination of the belt in the rope going to the car, i.e., the cogged belts 2 connect in a vertical and non-inclined manner to the deflecting pulley and to the driving pulley 9, such that the horizontal component attempting to tip the car 1 by creating a tug, discomfort, and great wear in the friction clamps, as well as a lack of uniformity in the translation of the car, is eliminated.

As a result of integrating the deflecting pulley 5 together with the machine 4, the reactions on the shaft of the machine 4 are reduced, which allows the shaft of the machine 4 to be of smaller size.

The support 10, which, on one hand, is fixed to the casing 12 of the machine 4 and, on the other hand, to the base 10, is use for housing a bearing, the function of which is to support the free end of the shaft of the machine 4 and the deflecting pulley 5 and be the carrier of the non-slip rollers 14.

At least one cogged driving pulley 9, which is flanked by discs or flanges preventing the cogged belts 2 from being able to come off from its position, is disposed on the shaft of the machine.

The non-slip rollers 14 are assembled such that their centers of rotation are located in an angle that can vary between approximately 70° and 190°. Therefore, the angle between the axes of rotation of the roller assemblies will coincide with the angle of contact of the belt 2, contacting the tangent point thereof with the driving pulley 9 (convergence between the belt 2 and pinion 9). The distance between the outer diameters of the non-slip pulleys 14 and those of the driving pulleys 9 is sufficient so that the thickness of the driving belt 2 passes, assuring the traction in both directions and eliminating the risk of drive loss due to the cogs of the belt 2 coming off from those of the pinion 9.

The machine 4 driving the drive system is mounted on a base 10. The assembly formed by the machine 4 and the base 10 is fixed to the wall, to the guides of the counterweight 6, to the ceiling, or to one of the car guides 20, or in any combination of any of two or three of these four elements. The base 10, together with the machine 4, is solely located in the projection of the counterweight 6 so that it enables the car 1 to pass by the side of the machine-base assembly.

In an alternative exemplary embodiment, the base 10 can be fixed to a combination of the elements listed above.

Integration of the deflecting pulley 5 to the support 10 favors operating and constructing the machine 4 by distributing the loads between two axes. Therefore, the shaft of the driving pulley 9 only receives a load component from the car rope, which allows a reduction in the diameters of the shaft and bearing.

All of the above enables a maximum use of the elevator hoistway 18, allowing for maximization of the car area for several existing hoistway dimensions, it being possible to carry a larger number of passengers or objects at once.

Finally, FIG. 8 shows the features of the deflecting pulleys 3, which, in a possible exemplary embodiment, are manufactured from plastic. The deflecting pulleys 3 are mounted on a shaft 15, at the ends of which are bearings 17. Each of the pulleys 3 has its own chanellings separated by a flange 16. The chanellings have a convexity or an outwardly dished shape for the purpose of keeping the belt 2 centered in the chanelling without the need of bordering with the flanks of the chanelling, thereby eliminating wear of the sides of the belt 2.

The elevator, in the cases of impact caused by an infinite traction situation, can be provided with shock absorbers at both ends of the path, electrical elements, such as limit switches, interrupting the movement before the elevator collides with the shock absorbing pads.

As a result of the constructive features of the elements used, the configuration thereof, and the synergy produced therebetween, the following advantages are achieved:

on one hand, the car moves without sliding and the car has a minimum weight, therefore, a bigger car with a greater useful load can be made. The car can be made from light materials without the need of having to use steel;
on the other hand, because the machine is in the projection of the counterweight, a greater use in the upper and lower areas of the hoistway is achieved;
the deflecting pulleys and the cogged pulleys can have a smaller diameter;
the necessary torque of the machine is much less than that torque required up until now;
the walls of the building do not have to support the total weight of the elevator; and
the possibility of placing the pulleys and the safety device(s) both on the ceiling and on the floor.

Above all, a translation of the car with the minimum noise possible and with the greatest comfort is made possible because the translation is performed in a uniform and vertical manner.

Having sufficiently described the nature of the present invention as well as a way of carrying it out to practice, it must be stated that it may be carried out into practice within its essentiality in other embodiments differing in detail from that indicated by way of example, which embodiments will also achieve the protection sought provided that the essential principle is not altered, changed or modified.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An elevator, comprising:
an elevator car movable in an elevator hoistway;
at least one cogged belt having:
ends;
a belt width;
a geometry with two faces including a flat face and a cogged face formed by inclined cogs placed in a staggered formation;
two portions attached to one another by extrusion, the two portions including a plastic portion and steel cords embedded in the plastic portion; and
three elements including transparent polyurethane, steel reinforcement cables embedded in the polyurethane and a textile mesh covering the cogged face;
a counterweight movably disposed within the hoistway and operably connected to the at least one cogged belt;
deflecting pulleys disposed at least one of above and below the elevator car and operably connected to the at least one cogged belt;
fastenings disposed in an upper portion of the hoistway and operable to fasten the ends of the at least one cogged belt;
a machine disposed in a projection of the counterweight at a side of the hoistway comprising:
a gearless motor having:
a motor shaft;
a second deflecting pulley operably associated with the at least one cogged belt;
at least two non-slip rollers;
a brake; and
a base on which is mounted the motor, the second deflecting pulley, and the brake;
at least one cogged driving pulley operatively connected to the motor shaft, operable to drive the at least one cogged belt, being made of a single part defining a central groove, being self-centering, and having:
a pulley width greater than the belt width;
a diameter of at least 100 mm; and
helical cogs;
at least one of discs and flanges flanking the at least one cogged driving pulley, the at least two non-slip rollers preventing the at least one cogged belt from coming off the at least one cogged driving pulley.

2. The elevator according to claim 1, which further comprises:
at least one car guide operable to guide the elevator car and defining a car guide plane; and
a step, the deflecting pulleys having axes oriented perpendicular to the car guide plane and disposed between the at least one car guide and the step.

3. The elevator according to claim 1, wherein:
the motor has a rear portion; and
the brake is mounted on one of the base and the rear portion of the motor.

4. The elevator according to claim 1, wherein:
the at least one cogged belt has:
a thickness of approximately 4 mm to 6 mm; and
a non-cogged portion with a thickness of less than approximately 3 mm; and
the belt width of the at least one cogged belt is less than approximately 30 mm.

5. The elevator according to claim 1, wherein the at least two non-slip rollers:
are operable to prevent the at least one cogged belt from coming off of the at least one cogged driving pulley; and
have centers of rotation perpendicular to a tangent of entry and exit points of the at least one cogged belt with respect to the at least one cogged driving pulley.

6. The elevator according to claim 5, wherein the at least two non-slip rollers have centers of rotation disposed at an angle varying between approximately 70° and 190°.

7. The elevator according to claim 1, which further comprises a shaft and bearings, the deflecting pulleys being mounted on the shaft at the ends of which are disposed the bearings, each of the deflecting pulleys having chanellings separated by a flange, the chanellings having one of a convexity and an outwardly dished shape.

8. The elevator according to claim 1, which further comprises car guides, and wherein:
the counterweight has guides; and
an assembly formed by the machine and the base is fixed one of:
to the wall of the hoistway;
to the guides of the counterweight;
to the ceiling of the hoistway;
to one of the car guides;
a combination of two of the above; and
a combination of three of the above.

9. The elevator according to claim 1, wherein the at least one cogged driving pulley has the helical cogs with a passage therebetween of approximately 7 mm and 9 mm and with a width 1 mm greater than the belt width.
